(19) United States
(12) Patent Application Publication
(10) Pub. No.: US 2014/0247213 A1
(43) Pub. Date: Sep. 4, 2014

(54) CURSOR-CONTROL DEVICES AND METHODS THEREOF

(71) Applicant: DELTA ELECTRONICS, INC., Kuei San (TW)

(72) Inventor: Tung-Chin WU, Kuei San (TW)

(73) Assignee: DELTA ELECTRONICS, INC., Kuei San (TW)

(21) Appl. No.: 14/078,873

(22) Filed: Nov. 13, 2013

(30) Foreign Application Priority Data
Mar. 4, 2013 (TW) 102107437

(51) Int. Cl. G06F 3/038

(52) U.S. Cl. CPC G06F 3/038
USPC 345/157

(57) ABSTRACT

A cursor-control device is provided for an electrical device having a display unit. The cursor-control device includes a button, an image-capture unit and a processing unit. The image-capture unit obtains a screen from the display unit. The processing unit determines cursor coordinates according to the screen, detects the number of times the button has been pressed and released, and determines whether to transmit a double-click signal to the electrical device according to the number of times of the button switching. When the button becomes pressed or released, the number of times of the button switching increases by one. Also, when the number of times of the button switching reaches two, the processing unit stores the cursor coordinates.

### CROSS REFERENCE TO RELATED APPLICATIONS

This Application claims priority of Taiwan Patent Application No. 102107437, filed on Mar. 4, 2013, the entirety of which is incorporated by reference herein.

### TECHNICAL FIELD

The invention relates to cursor-control devices, and more particularly to a cursor-control device for controlling a cursor according to the screen output by an electrical device.

### BACKGROUND

Current wireless presentation controllers, such as laser pointers, are a frequently used tool in business and academic presentations. During the presentation, the speaker usually uses such devices to highlight points on an image on a projection screen. In order to change the page of presentation, the speaker usually needs to stand next to the computer, and control the mouse or keyboard to operate the page-changing protocol. Meanwhile, the speaker uses a laser pointer to point at the target on the projection screen. However, in order for the speaker to be able to operate the computer easier, a button may set in a wireless presentation controller to replace the mouse button, and perform the operation of the mouse. Therefore, the user does not need to stand next to the computer to operate the mouse.

The disadvantage of such wireless presentation controllers is that it is hard to point to an accurate position on the screen to perform a double-click operation as well as with using a mouse, because the wireless presentation controller is handheld. When the wireless presentation controller points to a projection screen and its button is pressed by the user, the press causes the wireless presentation controller to shift, so that it is hard for the user to double-click on a position on the projection screen. Therefore, when a user attempts to operate an application program, he needs to hold the controller stable or repeat the double-click.

### SUMMARY

In order to solve the problems described above, the present invention provides a cursor-control device for an electrical device having a display unit. The cursor-control device comprises: a button; an image-capture unit, obtaining a screen from the display unit; and a processing unit, determining cursor coordinates according to the screen, detecting the number of times of the button switching, and determining whether to transmit a double-click signal to the electrical device according to the number of times of the button switching; wherein the number of times of the button switching increases by one when the button becomes pressed or released, and the processing unit stores the cursor coordinates when the number of times of the button switching reaches two.

In an embodiment, when the number of times of the button switching reaches four, the processing unit transmits the double-click signal to the electrical device according to the stored cursor coordinates.

In an embodiment, the processing unit further determines whether the button is pressed in a first predetermined period after the number of times of the button switching reaches four, and wherein when the button is not pressed during the first predetermined period, the processing unit transmits the double-click signal to the electrical device according to the stored cursor coordinates. When the button is pressed during the first predetermined period, the processing unit resets the number of times of the button switching to 0.

In an embodiment, the processing unit further detects whether the button is pressed in a second predetermined period after the number of times of the button switching reaches two, and wherein when the button is not pressed in the second predetermined period, the processing unit resets the number of times of the button switching to 0.

In an embodiment, the first predetermined period and the second predetermined period may be between 100 milliseconds and 600 milliseconds.

The invention further provides a cursor-control method for an electrical device having a display unit. The method comprises: obtaining a screen from the display unit; determining cursor coordinates according to the screen; detecting the number of times of the button switching; increasing the number of times of the button switching by one when the button becomes pressed or released; storing the cursor coordinates when the number of times of the button switching reaches two; and determining whether to transmit a double-click signal to the electrical device according to the number of times of the button switching.

In an embodiment, the cursor-control method further comprises: when the number of times of the button switching reaches four, transmitting the double-click signal to the electrical device according to the stored cursor coordinates.

In an embodiment, the cursor-control method further comprises: determining whether the button is pressed in a first predetermined period after the number of times of the button switching reaches four; and when the button is not pressed during the first predetermined period, transmitting the double-click signal to the electrical device according to the stored cursor coordinates.

In an embodiment, the cursor-control method further comprises: when the button is pressed during the first predetermined period, resetting the number of times of the button switching to 0.

In an embodiment, the cursor-control method further comprises: determining whether the button is pressed in a second predetermined period after the number of times of the button switching reaches two; and when the button is not pressed in the second predetermined period, resetting the number of times of the button switching to 0.

In an embodiment, the first predetermined period and the second predetermined period may be between 100 milliseconds and 600 milliseconds.

### BRIEF DESCRIPTION OF DRAWINGS

The invention will become more fully understood by referring to the following detailed description with reference to the accompanying drawings, wherein:

FIG. 1 is a block diagram illustrating an embodiment of a cursor-control device according to the invention;

FIG. 2 is a schematic diagram illustrating an embodiment of a signal generated when a button is pressed or released by a user;

FIG. 3 is a block diagram illustrating an embodiment of a cursor-control device according to the invention; and

FIG. 4 is a flowchart of an embodiment of an operation method for the cursor-control device shown in FIG. 1.

### DESCRIPTION OF EMBODIMENTS

Embodiments, or examples, illustrated in the drawing are now disclosed using specific language. It will nevertheless be understood that the embodiments and examples are not intended to be limiting. Any alterations and modifications in the disclosed embodiments, and any further applications of the principles disclosed in this document are contemplated as would normally occur to one of ordinary skill in the pertinent art. Reference numbers may be repeated throughout the embodiments, but they do not require that feature(s) of one embodiment apply to another embodiment, even if they share the same reference number.

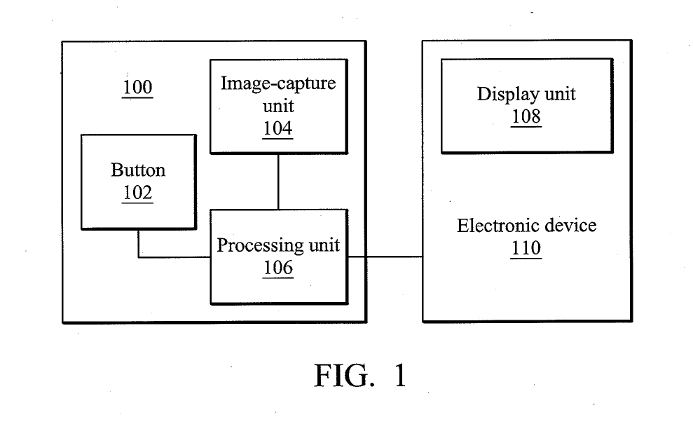

FIG. 1 is a block diagram illustrating an embodiment of a cursor-control device according to the invention. The cursor-control device 100 comprises a button 102, an image-capture unit 104 and a processing unit 106. A display unit 108 is configured to output the corresponding screen, and the cursor-control device 100 is an input interface for an electronic device 110. For example, the electronic device 110 may be a computer device or a notebook, the display unit 108 may be a projector or an LCD, and the cursor-control device 100 is used for controlling the movement operation or click operation of the cursor on the screen. It should be noted that the display unit 108 is not limited to being installed in the electronic device 110. In some embodiments, the display unit 108 may be an external display unit, such as projector or an LCD, which can be connected to the electronic device 110 and displays the image output of the electronic device 110.

The operations of the cursor-control device 100 are described below. The button 102 of the cursor-control device 100 is used for a user to operate a select operation or an execute operation of the cursor, such as the click operation of a mouse. The image-capture unit 104 of the cursor-control device 100 is configured to capture a screen from the display unit and transmit the screen information to the processing unit 106. When the processing unit 106 receives the screen information, the processing unit 106 determines the cursor coordinates according to the screen. For example, the processing unit 106 may determine the cursor coordinates according to a blanking signal hiding in the screen, and transmit the cursor coordinates to the processing unit 106. Therefore, the user can move the cursor by changing the direction in which the image-capture unit 104 is pointing, and the electronic device 110 can move the cursor on the screen according to the cursor coordinates determined by the processing unit 106.

In addition, the processing unit 106 also detects when the button 102 is pressed or released. When the user clicks the button 102, the processing unit 106 transmits a corresponding signal to the electronic' device 110. At this time, the electronic device 110 selects or executes the item at which the cursor is pointing, and it is similar to the left-click of a mouse. It should be noted that the processing unit 106 can transmit the cursor operation signal to the electronic device 110 via wire or wireless.

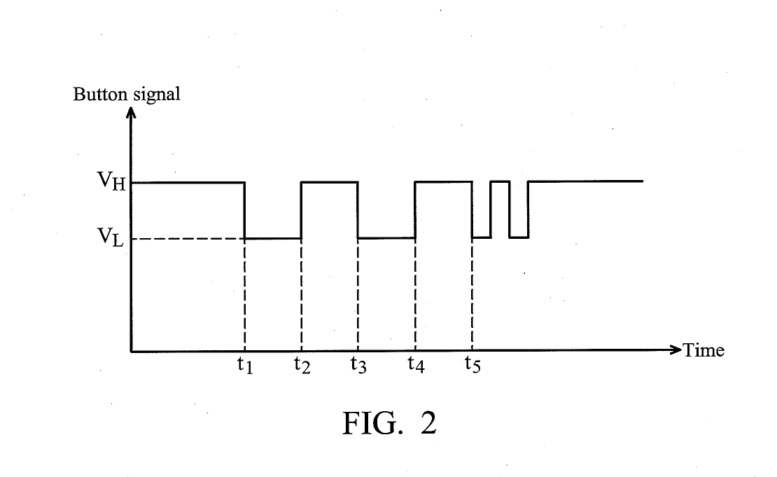

When a user attempts to double-click the same block, the second click may cause the cursor to shift from the target, because the cursor-control device trembles when pressed by hand. Therefore, it is hard for the electronic device 110 to determine the operation of a double-click by the user, and it is difficult for the user to operate. In order to solve this problem, the processing unit 106 detects the number of times the button 102 has been pressed and released, and determines whether to transmit a double-click signal to the electrical device 110 according to the number of times of the button switching. The operations of the processing unit 106 are described with FIG. 2 in the following paragraphs.

FIG. 2 is a schematic diagram illustrating an embodiment of a signal generated when a button is pressed or released by a user. The button signal falls to voltage level V_{L} when the button 102 is pressed, and the button signal returns to voltage level V_{H} when the button 102 is released. Therefore, the processing unit 106 may detect the operation of the button 102 according to the voltage level of the button signal. For example, when a user presses the button 102 at time t₁, the processing unit 106 can detect the button 102 has been changed according to the change in the voltage level of the button signal, and the processing unit 106 adds one to the number of times of the button switching. Similarly, when the user releases the button 102 at time t₂, the processing unit 106 can detect the button 102 has been changed according to the change in the voltage level of the button signal, and the processing unit 106 adds one to the number of times of the button switching. In other words, when the user clicks the button 102 one time, it means that the button has been pressed at time t₁ and released at time t₂, and the number of times of the button switching will be 2.

Next, when the processor unit 106 determines that the number of times of the button switching has reached 2 (at time t₂), the processor unit 106 stores the current cursor coordinates. When the processor unit 106 determines that the number of times of the button switching has reached 4 (at time t₄), namely the user double-clicks the button 102, the processor unit 106 generates a cursor double-click signal with the stored cursor coordinates, and resets the number of times of the button switching to 0. It should be noted that the cursor double-click signal comprises a button double-click signal (the two impulse waves after time t₅) and the cursor coordinates. Also, the processor unit 106 uses the cursor coordinates corresponding to the first click (time t₂) to generate the cursor double-click signal. Therefore, when the electronic device 110 receives the cursor double-click signal from the processor unit 106, the electronic device 110 will recognize that the double-click points to the cursor coordinates of the first click, and it is similar to the double-click operation of a mouse. Accordingly, although the cursor-control device shifts by the double-click operation, the electronic device 110 can still recognize the double-click operation performed by the user.

In some embodiments, the processor unit 106 further determines whether the interval between the two clicks of the button is smaller than a first predetermined period, in order to avoid an operation of two individual clicks being accidentally identified as a double-click operation. For example, the processor unit 106 further determines whether the button 102 is pressed in a predetermined period after the number of times of the button switching reaches two, wherein the predetermined period may be set at 100 to 600 milliseconds. If the button 102 is pressed in the predetermined period, namely the period between time t₂ and time t₃ is smaller than the predetermined period, the click operation may be identified as a double-click operation, so that the processor unit 106 continues counting the number of times of the button switching. And the processor unit 106 transmits the cursor double-click signal to the electronic device 110 when the number of times of the button switching reaches 4. On the other hand, if the button 102 is pressed in the predetermined period after the number of times of the button switching reaches two, namely the period between time t₂ and time t₃ is larger than the predetermined period, the click operation may be identified as an individual-click operation, and the processor unit 106 will reset the number of times of the button switching to 0. Also, because the number of times of the button switching is set to 0 at time t₂, the number of times of the button switching is only 2 at time t₄, and the processor unit 106 will not generate the cursor double-click signal to the electronic device 110 after time t₄.

In some embodiments, the processor unit 106 further determines whether the button 102 is pressed in a predetermined period after the number of times of the button switching reaches 4, wherein the predetermined period may be set at 100 to 600 milliseconds. It means that the processor unit 106 determines whether the button 102 is pressed in a predetermined period after time t₄. When the button 102 is pressed in the predetermined period, the processor unit 106 resets the number of times of the button switching to 0, and does not transmit the cursor double-click signal to the electronic device 110. Therefore, although the user continues clicking for a drawing or writing operation, the continuous clicks of the operation will not be identified as a double-click operation. On the other hand, when the button 102 is not pressed in a predetermined period, the processor unit 106 will transmit the cursor double-click signal to the electronic device 110 at time t₅ of FIG. 2.

It should be noted that the button signal is not only provided to the processor unit 106, but also to the electronic device 110. Therefore, the electronic device 110 can react to the operation of the user in real-time.

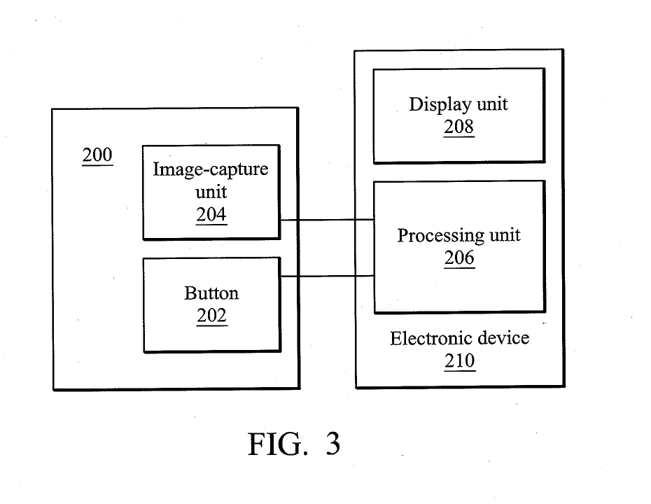

In some embodiments, the processor unit 106 can be installed in the electronic device 110, as shown in FIG. 3. The operations of the button 202, the image-capture unit 204 and the processing unit 206 are similar to the operations of the button 102, the image-capture unit 104 and the processing unit 106, so the details are omitted here for brevity. Also, signals generated by the button 202 and the image-capture unit 204 can be transmitted to the electronic device 210 via wire or wireless. Because the transmission is not the point of the invention, the related details are omitted here. It should be noted that, if the display unit 208 is an external display or a projector, the processor unit 206 can be installed in the display unit 208.

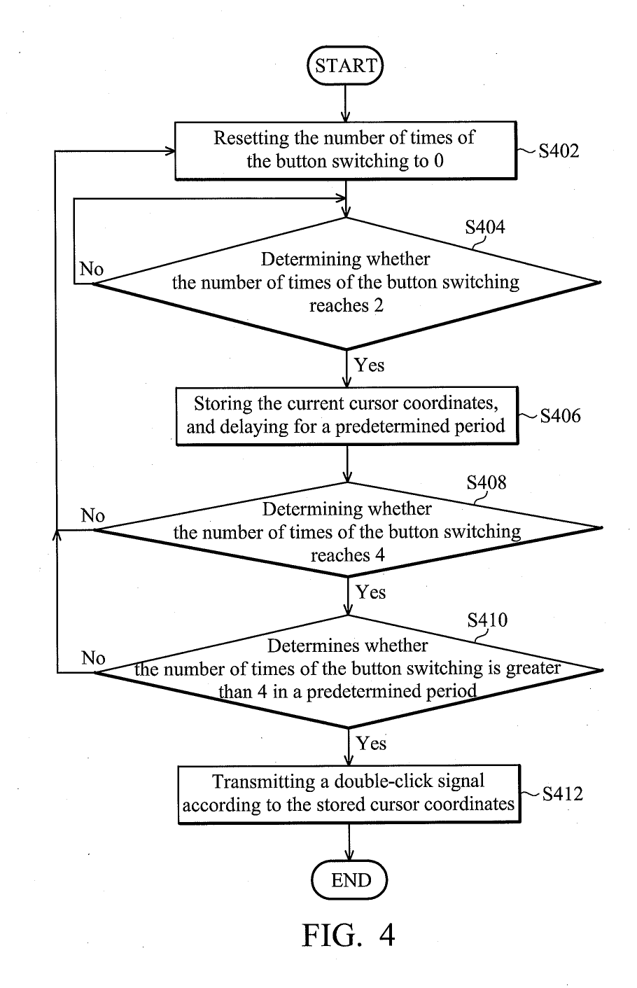

FIG. 4 is a flowchart of a preferred embodiment of an operation method for the cursor-control device shown in FIG. 1. It should be noted that, whenever the button 102 is pressed or released in the process of the steps, the processor unit 106 adds 1 to the number of times of the button switching. In step S402, the processor unit 106 resets the number of times of the button switching to 0. Next, in step S404, the processor unit 106 determines whether the number of times of the button switching reaches two. If the number of times of the button switching does not reach two in step S404, the processor unit 106 continues detecting the number of times of the button switching. On the other hand, if the number of times of the button switching reaches two, the method proceeds to step S406.

In step S406, the processor unit 106 stores the current cursor coordinates, and the method proceeds to step S406 after delaying for a predetermined period. Next, in step S408, the processor unit 106 determines whether the number of times of the button switching reaches 4. If the number of times of the button switching is 4, the method proceeds to step S410. On the other hand, if the number of times of the button switching is not 4, the method returns to step S402, and the number of times of the button switching is reset to 0.

Next, in step S410, the processor unit 106 determines whether the number of times of the button switching is greater than 4 in a predetermined period. It means the processor unit 106 determines whether the button 102 is pressed in the predetermined period after the number of times of the button switching reaches 4. When the number of times of the button switching is not changed in the predetermined period (still 4 times), the method proceeds to step S412. On the other hand, when the number of times of the button switching is greater than 4 within a predetermined period, the method returns to step S402, and the number of times of the button switching is reset to 0.

Finally, in step S412, the processor unit 106 transmits a double-click signal to the electrical device 110 according to the stored cursor coordinates. Further, when step S412 is completed, the method may return to step S402 for resetting the number of times of the button switching to 0, and the cursor control operation continues.

The present invention may also be at least partially embodied in the form of computer program code embodied in tangible machine-readable storage media, such as random access memory (RAM), read only memories (ROMs), CD-ROMs, DVD-ROMs, BD-ROMs, hard disk drives, flash memories, or any other machine-readable storage medium, wherein, when the computer program code is loaded into and executed by a computer, the computer becomes an apparatus for practicing the invention. The present invention may be embodied at least partially in the form of computer program code, whether loaded into and/or executed by a computer, such that, when the computer program code is loaded into and executed by a computer, the computer becomes an apparatus for practicing the invention. When implemented on a general-purpose processor, the computer program code segments configure the processor to create specific logic circuits. The invention may alternatively be at least partially embodied in a digital signal processor formed of application-specific integrated circuits for performing a method according to the principles of the invention.

The particular feature, structure or character described in “an embodiment” or “an example” of the present specification should be included in at least one embodiment of the present specification. Therefore, the statement of “in an embodiment” appearing in different places of the specification may not refer to the same embodiment. In addition, this particular feature, structure or character may be incorporated with one or more embodiments in any suitable way.

One skilled in the art can easily understand the advantages of the embodiments mentioned above. After reading the present specification, those who are skilled in this technology can still make various alterations and modifications without departing from the scope and spirit of this invention. Accordingly, the present specification is used for protecting the scope of the claims of the present invention, and it is not intended to limit the present invention. Further, the present invention may repeat the same index numerals and/or words in different embodiments. The repeated numerals and/or words are used to simplify and clarify the present invention, and not to indicate that the structures in the different embodiments must have the same characteristics.

What is claimed is:

1. A cursor-control device for an electrical device having a display unit, comprising:
a button;
an image-capture unit, obtaining a screen from the display unit; and
a processing unit, determining cursor coordinates according to the screen, detecting the number of times of the button switching, and determining whether to transmit a double-click signal to the electrical device according to the number of times of the button switching;
wherein the number of times of the button switching increases by one when the button becomes pressed or released, and the processing unit stores the cursor coordinates when the number of times of the button switching reaches two.

2. The cursor-control device of claim 1, wherein when the number of times of the button switching reaches four, the processing unit transmits the double-click signal to the electrical device according to the stored cursor coordinates.

3. The cursor-control device of claim 1, wherein the processing unit further determines whether the button is pressed in a first predetermined period after the number of times of the button switching reaches four, and wherein when the button is not pressed during the first predetermined period, the processing unit transmits the double-click signal to the electrical device according to the stored cursor coordinates.

4. The cursor-control device of claim 3, wherein the first predetermined period is between 100 milliseconds and 600 milliseconds.

5. The cursor-control device of claim 3, wherein when the button is pressed during the first predetermined period, the processing unit resets the number of times of the button switching to 0.

6. The cursor-control device of claim 1, wherein the processing unit further determines whether the button is pressed in a second predetermined period after the number of times of the button switching reaches two, and wherein when the button is not pressed in the second predetermined period, the processing unit resets the number of times of the button switching to 0.

7. The cursor-control device of claim 6, wherein the second predetermined period is between 100 milliseconds and 600 milliseconds.

8. A cursor-control method for an electrical device having a display unit, comprising:
obtaining a screen from the display unit;
determining cursor coordinates according to the screen;
detecting the number of times the button switching;
adding one to the number of times of the button switching when the button becomes pressed or released;
storing the cursor coordinates when the number of times of the button switching reaches two; and
determining whether to transmit a double-click signal to the electrical device according to the number of times of the button switching.

9. The cursor-control method of claim 8, further comprising: when the number of times of the button switching reaches four, transmitting the double-click signal to the electrical device according to the stored cursor coordinates.

10. The cursor-control method of claim 8, further comprising:
determining whether the button is pressed in a first predetermined period after the number of times of the button switching reaches four; and
when the button is not pressed during the first predetermined period, transmitting the double-click signal to the electrical device according to the stored cursor coordinates.

11. The cursor-control method of claim 10, wherein the first predetermined period is between 100 milliseconds and 600 milliseconds.

12. The cursor-control method of claim 10, further comprising: when the button is pressed during the first predetermined period, resetting the number of times of the button switching to 0.

13. The cursor-control method of claim 8, further comprising:
determining whether the button is pressed in a second predetermined period after the number of times of the button switching reaches two; and
when the button is not pressed in the second predetermined period, resetting the number of times of the button switching to 0.

14. The cursor-control method of claim 13, wherein the second predetermined period is between 100 milliseconds and 600 milliseconds.
